(19) United States
(12) Patent Application Publication
(10) Pub. No.: US 2019/0376837 A1
(43) Pub. Date: Dec. 12, 2019

(54) CONTROL DEVICE, ANIMAL TOILET, INFORMATION PROCESSING DEVICE, INFORMATION PROCESSING TERMINAL, AND CONTROL METHOD

(71) Applicant: SHARP KABUSHIKI KAISHA, Sakai City (JP)

(72) Inventor: SHIGEFUMI URATA, Sakai City (JP)

(21) Appl. No.: 16/431,942

(22) Filed: Jun. 5, 2019

(30) Foreign Application Priority Data
Jun. 8, 2018 (JP) 2018-110675

(51) Int. Cl. G01G 23/16; A01K 1/01; A01K 29/00

(52) U.S. Cl. CPC G01G 23/163; A01K 29/005; A01K 1/0107

(57) ABSTRACT

It is recognized that an offset is added to a measurement value shown by a weight scale. In a case where a measurement value, shown by a body weight scale, has decreased from a first reference value by more than a first threshold, an offset determining section determines whether or not a difference between the measurement value and a second reference value is greater than a second threshold. In a case where the offset determining section determines that the difference between the measurement value and the second reference value is greater than the second threshold, the offset determining section stores the measurement value as a candidate second reference value.

This Nonprovisional application claims priority under 35 U.S.C. § 119 on Patent Application No. 2018-110675 filed in Japan on Jun. 8, 2018, the entire contents of which are hereby incorporated by reference.

### TECHNICAL FIELD

The present invention relates to a control device, toilet, an information processing device, an information processing terminal, and a control method.

### BACKGROUND ART

Patent Literature 1 discloses an automatic body weight measuring system for a pet. The automatic body weight measuring system includes a weight scale which is provided to a pet toilet, and calculates, as a body weight of a pet, a difference between (i) a measurement value shown by the weight scale while the pet stays on the pet toilet and (ii) measurement value shown by the weight scale immediately before the pet steps on the pet toilet.

### CITATION LIST

### Patent Literature

### Patent Literature 1

Japanese Patent Application Publication, Tokukai, No. 2007-330200

### SUMMARY OF INVENTION

### Technical Problem

A weight scale may show a measurement value having an absolute value to which an offset (deviation) is added, in a case where the weight scale is subjected to an impact or the like. However, Patent Literature 1 does not assume a case where an offset is added to a measurement value shown by the weight scale. Therefore, according to the automatic body weight measuring system for a pet disclosed in Patent Literature 1, even in a case where an offset is added to a measurement value shown by the weight scale, it is not possible for a user and the automatic body weight measuring system to recognize a fact that the offset is added to the measurement value shown by the weight scale, and accordingly it is not possible to obtain various kinds of information with use of an absolute value of the measurement value shown by the weight scale.

One or more aspects of the present invention have been made in view of the above conventional problem, and an object of the one or more aspects of the present invention is to provide a control device, a toilet, an information processing device, an information processing terminal, and a control method, each of which allows recognition of a fact that an offset is added to a measurement value shown by a weight scale.

### Solution to Problem

In order to attain the above object, a control device in accordance with an aspect of the present invention is a control device which controls an animal toilet, the control device including: a measurement value obtaining section which obtains, over time, information indicative of a measurement value shown by a weight scale that is included in the animal toilet and that measures a body weight of an animal; a first reference value setting section which sets, as a first reference value, the measurement value shown by the weight scale while a steady-state load is applied to the weight scale; and an offset determining section which sets, as a second reference value, the measurement value shown by the weight scale and regarded as a measurement value shown while no load is applied to the weight scale, in a case where the measurement value, which has been shown by the weight scale and which has been obtained by the measurement value obtaining section, has decreased from the first reference value by more than a first threshold, the offset determining section determining whether or not a difference between the measurement value and the second reference value is greater than a second threshold, in a case where the offset determining section determines that the difference between the measurement value and the second reference value is greater than the second threshold, the offset determining section storing the measurement value as a candidate second reference value.

In order to attain the above object, a control method in accordance with an aspect of the present invention is a control method carried out by a control device which controls a measurement value shown by a weight scale that measures a body weight of an animal, the control method including: a measurement value obtaining step of obtaining, over time, information indicative of a measurement value shown by the weight scale; a first reference value setting step of setting, as a first reference value, the measurement value shown by the weight scale while a steady-state load is applied to the weight scale; and a second reference value setting step of setting, as a second reference value, the measurement value shown by the weight scale and regarded as a measurement value shown while no load is applied to the weight scale, in the second reference value setting step, in a case where the measurement value, which has been shown by the weight scale and which has been obtained in the measurement value obtaining step, has decreased from the first reference value by more than a first threshold, it being determined whether or not a difference between the measurement value and the second reference value is greater than a second threshold, in a case where it is determined that the difference between the measurement value and the second reference value is greater than the second threshold, the measurement value being set as a candidate second reference value.

### Advantageous Effects of Invention

According to an aspect of the present invention, it is possible to provide a control device, a toilet, an information processing device, an information processing terminal, and a control method, each of which allows recognition of a fact that an offset is added to a measurement value shown by a weight scale.

### BRIEF DESCRIPTION OF DRAWINGS

FIG. 1A is a perspective view illustrating a configuration of a pet toilet, including a weight scale, in accordance with Embodiment 1 of the present invention. FIG. 1B is an exploded perspective view illustrating the configuration of the pet toilet.

FIG. 2 is a cross-sectional view illustrating the configuration of the pet toilet.

FIG. 3 is a block diagram illustrating a configuration of a control device of the pet toilet.

FIG. 4 is a view illustrating a state in which, in the pet toilet in accordance with Embodiment 1, determination of whether or not an offset is added is started on the basis of a variation with time in a measurement value shown by body weight scales before the offset is added.

FIG. 5 is a view illustrating a state in which, in the pet toilet in accordance with Embodiment 1, it is determined that the offset is not added, on the basis of the variation with time in the measurement value shown by the body weight scales before the offset is added.

FIG. 6 is a view illustrating a state in which, in the pet toilet in accordance with Embodiment 1, the determination of whether or not the offset is added is started on the basis of the variation with time in the measurement value shown by the body weight scales while the offset is added.

FIG. 7 is a view illustrating a state in which, in the pet toilet in accordance with Embodiment 1, it is determined that the offset is added, on the basis of the variation with time in the measurement value shown by the body weight scales while the offset is added.

FIG. 8 is a flowchart illustrating a flow of a process carried out by the control device of the pet toilet in accordance with Embodiment 1.

FIG. 9 is a view illustrating a state in which, in a pet toilet in accordance with Embodiment 2, (i) it is determined that an offset is added, on the basis of a variation with time in a measurement value shown by body weight scales while the offset is added and (ii) the offset is corrected.

FIG. 10 is a block diagram illustrating a configuration of a pet toilet, a smartphone, arid a server in accordance with Embodiment 3.

FIG. 11 is a block diagram illustrating a configuration of a pet toilet, a smartphone, and a server in accordance with a variation of Embodiment 3.

### DESCRIPTION OF EMBODIMENTS

### Embodiment 1

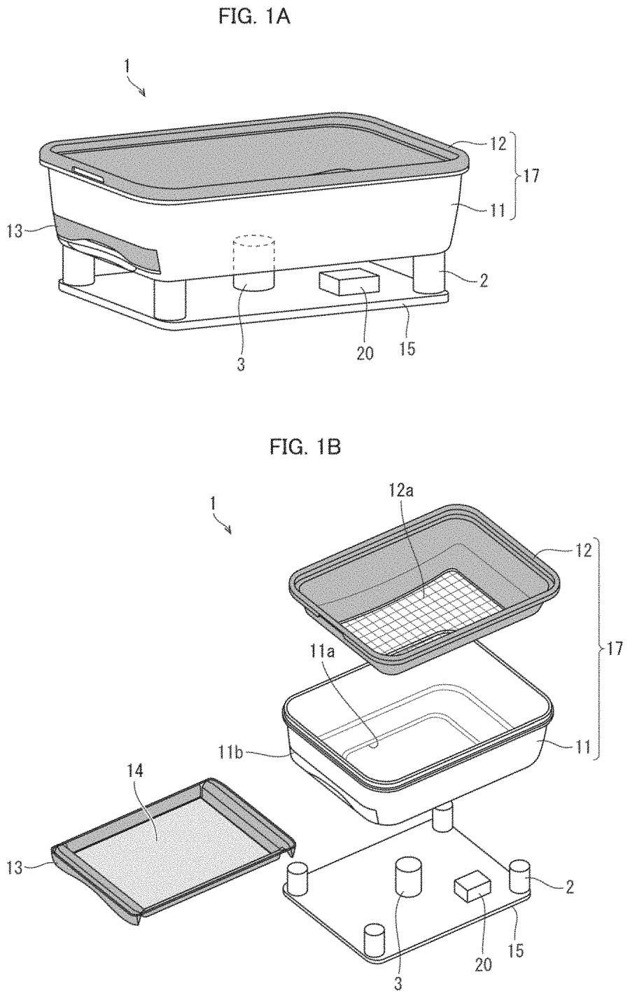

The following description will discuss Embodiment 1 of the present invention with reference to FIGS. 1 through 8. A pet toilet in accordance with Embodiment 1, which is a toilet and which includes body weight scales 2, has a function of, for example, (i) measuring a body weight of a pet and (ii) measuring a weight of excreta of the pet. Examples of the pet include animals kept at home, such as cats and dogs. Note, however, that a toilet in accordance with an aspect of the present invention is not necessarily limited to the animals such as cats and dogs, and can be applied to the other animals. For example, the toilet can be applied to a human Note also that the excreta can be any one of urine and feces.

### Configuration of Pet Toilet 1

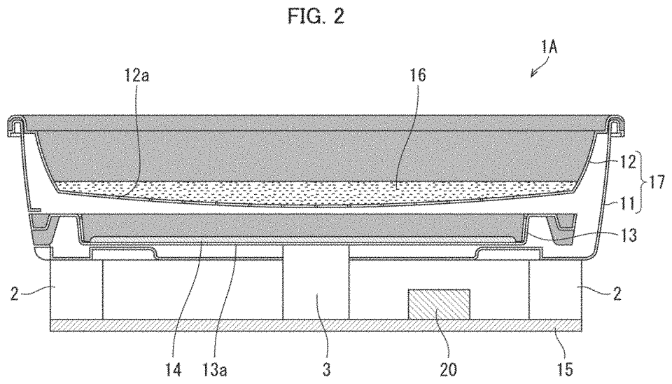

A pet toilet 1 in accordance with Embodiment 1 has a function of a weight measuring device which measures a body weight of a pet, which is an animal, and a weight of excreta of the pet. The excreta can be any one of urine and feces. Embodiment 1 will be described based on the premise that the excreta are urine. A configuration of the pet toilet 1 in accordance with Embodiment 1, which is a toilet and which includes a control device 20, will be described with reference to FIGS. 1A, 1B, and 2. FIG. 1A is a perspective view illustrating the configuration of the pet toilet 1 in accordance with Embodiment 1, which includes the control device 20. FIG. 1B is an exploded perspective view illustrating the configuration of the pet toilet 1. FIG. 2 is a cross-sectional view illustrating the configuration of the pet toilet 1.

As illustrated in FIGS. 1A, 1B, and 2, the pet toilet 1 includes a main container 11, an excretion stage 12, an excreta tray 13, an absorbing sheet 14, a supporting plate 15, body weight scales (weight scale) 2, an excreta weight scale 3, the control device 20, and a cover (not illustrated). Note that the main container 11 and the excretion stage 12 may be collectively referred to as an upper unit 17.

The main container 11 supports he excretion stage 12. The excretion stage 12 is a stage onto which the pet steps and on which the animal excretes. The excretion stage 12 has a mesh part 12a on a bottom surface thereof. The mesh part 12a allows a liquid to pass therethrough, but does not allow, for example, feces and an object (toy), which has been brought by the animal, to pass therethrough. The mesh part 12a can be formed from a liquid permeable cloth, a liquid permeable thin film, or the like. The excretion stage 12 can alternatively have a hole through which excreta pass, instead of the mesh part 12a. According to Embodiment 1, the excretion stage 12 is a container having a depressed shape. However, the excretion stage 12 can have any shape, provided that the excretion stage 12 allows the animal to step onto the excretion stage 12. Note that, in a case where the pet is a cat, litter 16 onto which the cat steps can be laid on the mesh part 12a, as illustrated in FIG. 2. This litter 16 for a cat is disposed of and replaced with new litter 16, in a case where excreta of the cat adhere to the litter 16. Thus, the litter 16 is a consumable item used for the pet toilet 1.

The excreta of the pet drops on the absorbing sheet 14 laid on a bottom plate of the excreta tray 13. According to Embodiment 1, the excretion stage 12 has a shape of a depressed container. However, the excretion stage 12 can have any shape, provided that the excretion stage 12 allows the pet to step onto the excretion stage 12 for measurement of a body weight of the pet. The excreta tray 13 is a member which is disposed under the excretion stage 12 and which receives the excreta. The excreta tray 13 can be inserted into and drawn out from a side hole formed in a side surface of the main container 11.

The absorbing sheet 14 is a sheet which absorbs liquid such as urine. The absorbing sheet 14 is convenient in that, after the absorbing sheet 14 absorbs a liquid such as urine, the absorbing sheet 14 can be disposed of and replaced with a new absorbing sheet 14. In other words, the absorbing sheet 14 is a consumable item used for the pet toilet 1. The supporting plate 15 is a base plate which supports the body weight scales 2, the excreta weight scale 3, and the control device 20.

According to Embodiment 1, the body weight scales 2 are provided at, for example, respective four corners of a rectangular bottom part of the main container 11 so that the body weight scales 2 support the rectangular bottom part of the main container 11. The body weight scales 2 include respective load cells (not illustrated). As such, the body weight scales 2 measure a total weight of the main container 11, in which the excretion stage 12 is disposed, and the pet by the load cells. As a result, it is possible to measure the body weight of the pet by subtracting a weight of the main container 11, in which the excretion stage 12 is disposed, from the total weight.

The excreta weight scale 3 measures the weight of the excreta of the pet by a load cell (not illustrated). According to Embodiment 1, the excreta weight scale 3 is provided at the middle of the supporting plate 15 having a rectangular shape. According to Embodiment 1, the excreta weight scale 3 is provided on the supporting plate 15 so that an upper surface of the excreta weight scale 3 is in contact with the bottom plate of the excreta tray 13. This causes the excreta tray 13, on which the absorbing sheet 14 is laid, to be supported at a single point. As a result, it is possible to measure a weight of urine, which is the excreta of the pet, by subtracting (i) a value of a weight of the absorbing sheet 14 which has not been used yet and (ii) a value of the weight of the excreta tray 13, from a measurement value shown by the excreta weight scale 3. According to Embodiment 1, the excreta weight scale 3 is provided on the supporting plate 15. Note, however, that a location of the excreta weight scale 3 is not limited to such a location.

Note that, according to Embodiment 1, the body weight scales 2 and the excreta weight scale 3 include the respective load cells (not illustrated) each serving as a load sensor. A load cell detects, as a change in a voltage, a change in a resistance value which change is caused by a strain. Note, however, that, according to an aspect of the present invention, the body weight scales 2 and the excreta weight scale 3 are each not necessarily limited to the load cell, and a weight scale of an electromagnetic force balancing type can be, for example, alternatively used. The weight scale of the electromagnetic force balancing type is configured so as to balance up a balance by an electromagnetic force and detect an electric current at that time.

### Configuration of Control Device

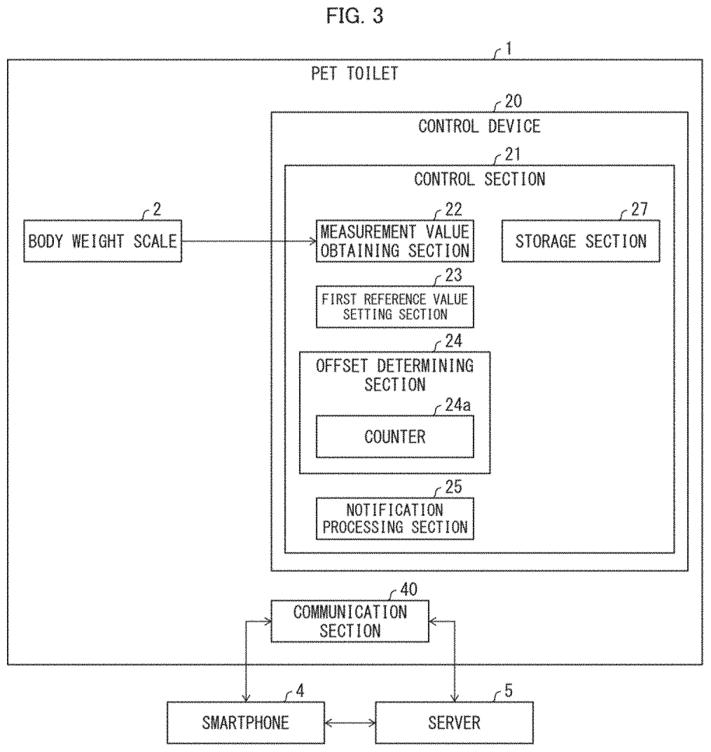

FIG. 3 is a block diagram illustrating a configuration of the control device 20 of the pet toilet 1 in accordance with Embodiment 1. The pet toilet 1 includes a communication section 40, in addition to the above-described body weight scales 2 and the above-described control device 20. The control device 20 controls the pet toilet 1. The control device 20 includes a control section 21 and a power source section (not illustrated). The control section includes a measurement value obtaining section 22, a first reference value setting section 23, an offset determining section 24, a notification processing section 25, and a storage section 27. Note that the control section 21 can further include an amplifier (AMP), an analog-to-digital converter (ADC), and/or the like.

The communication section 40 conducts communication with a server 5 via a telecommunication line such as the Internet. The communication section 40 can conduct communication with a smartphone 4 via a telecommunication line such as the Internet or can alternatively conduct near field communication such as Bluetooth (registered trademark) with the smartphone 4.

The measurement value obtaining section 22 obtains, over time, information indicative of a measurement value shown by the body weight scales 2, from the body weight scales 2 which measure the body weight of the pet that stays on the pet toilet 1. The first reference value setting section 23 sets, as a first reference value R1, the measurement value shown by the body weight scales 2 while a steady-state load is applied to the body weight scales 2.

In the offset determining section 24, a second reference value R2 is stored. The second reference value R2 is a value in accordance with which a measurement value W shown by the body weight scales 2 is regarded as a measurement value shown while no load is applied to the body weight scales 2. In a case where the measurement value W, which has been shown by the body weight scales 2 and which has been obtained by the measurement value obtaining section 22, has decreased from the first reference value R1 by a first threshold or more, the offset determining section 24 determines whether or not a difference between the measurement value W and the second reference value R2 is greater than a second threshold. In a case where the offset determining section 24 determines that the difference is greater than the second threshold, the offset determining section 24 sets the measurement value W as a candidate second reference value. The candidate second reference value is a candidate for a value which should be newly set as the second reference value R2 in consideration of an offset (deviation) in a case where the offset is added to the second reference value R2 which is already set. The offset determining section 24 includes a counter 24a. The offset determining section 24 counts, with use of the counter 24a, the number of times the candidate second reference value is set. In a case where the offset determining section 24 counts a given number of times, the offset determining section 24 determines, as an amount of the offset, a difference between the candidate second reference value and the second reference value which is currently set.

The notification processing section 25 causes a user to be notified of a fact that the offset is added to the measurement value shown by the body weight scales 2, in a case where the offset determining section 24 determines that the offset is added to the measurement value shown by the body weight scales 2. Examples of a process carried out by the notification processing section 25 so as to cause such a notification to be sent to the user include: causing, via the communication section 40, the smartphone 4 to carry out given display on its display screen; causing, via the communication section 40, the smartphone 4 to produce a sound through a speaker; and causing, via the communication section 40, the smartphone 4 to vibrate. Alternatively, in a case where the pet toilet 1 includes an LED, the notification processing section 25 causes the pet toilet 1 to light up or blink the LED. In a case where the pet toilet 1 includes a display screen, the notification processing section 25 causes the pet toilet 1 to carry out given display on the display screen. In a case where the pet toilet 1 includes a speaker, the notification processing section 25 causes the pet toilet 1 to produce a sound through the speaker.

The smartphone 4 is one example of an information processing terminal which the user carries with him/her and uses so as to conduct wireless communication with the pet toilet 1. The information processing terminal is not particularly limited to a smartphone, and can be alternatively a typical mobile phone, a tablet terminal, a PC (Personal Computer), or the like. The server 5 is, for example, a cloud server. The server 5 can be constituted by a single information processing device or can be alternatively constituted by a plurality of information processing devices.

### Method of Determining Whether or Not Offset is Added to Measurement Value Shown by Body Weight Scales 2

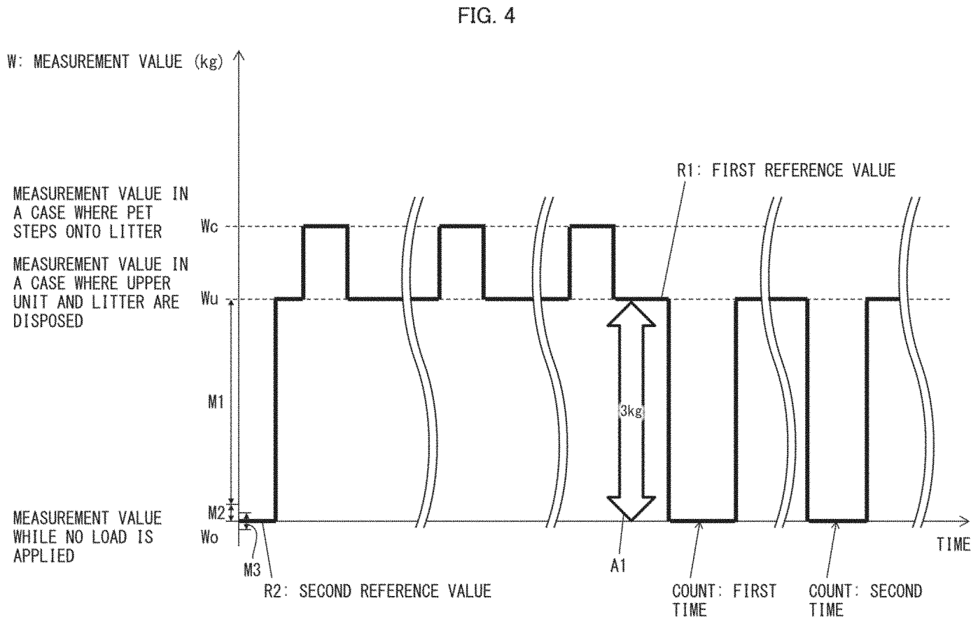

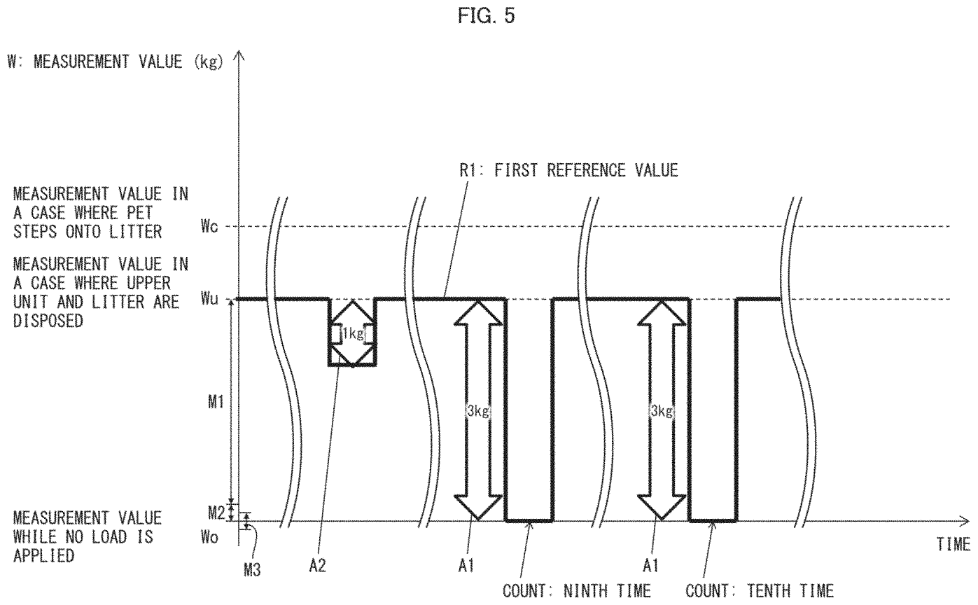

FIG. 4 is a view illustrating a state in which, in the pet toilet 1 in accordance with Embodiment 1, determination of whether or not the offset is added is started on the basis of a variation with time in the measurement value shown by the body weight scales 2 before the offset is added. FIG. 5 is a view illustrating a state in which, in the pet toilet 1 in accordance with Embodiment 1, it is determined. that the offset is not added, on the basis of the variation with time in the measurement value shown by the body weight scales 2 before the offset is added.

It is assumed that the measurement value shown by the body weight scales 2 is represented by W (kg). The measurement value W which is shown by the body weight scales 2 while no load is applied to the body weight scales 2 and to which the offset has not been added yet is regarded as an initial measurement value Wo. The measurement value W shown by the body weight scales 2 is set in advance so that the initial measurement value Wo is 0 (zero) (kg). That Wo=0 (zero) (kg) is stored in advance as the second reference value R2 in the offset determining section 24 before the pet toilet 1 is shipped from a factory or is alternatively stored in advance as the second reference value R2 in the offset determining section 24 by the user.

The measurement value W, shown by the body weight scales 2 while (i) the upper unit 17 on which the litter 16 is laid is disposed on the body weight scales 2 and (ii) a load of the litter 16 and the upper unit 17 is accordingly applied to the body weight scales 2, is regarded as a steady-state value Wu. A state in which the load of the litter 16 and the upper unit 17 is applied to the body weight scales 2 is a steady state in which the pet toilet 1 stands by to be used by the pet. In other words, the load of the litter 16 and the upper unit 17 is the steady-state load applied to the body weight scales 2. Therefore, in a case where the pet toilet 1 is in normal use, the steady-state value Wu is the measurement value W which is outputted to the measurement value obtaining section 22 from the body weight scales 2 and which is uniform for the longest time period within a given time period (e.g., one day, one week, or one month) set by the user as desired.

Thus, the first reference value setting section 23 extracts, from the measurement value W stored in the storage section 27 on a time-series basis by the measurement value obtaining section 22, a value which is uniform for the longest time period within the given time period set by the user as desired. The first reference value setting section 23 determines that the value thus extracted is the measurement value W shown while the steady-state load is applied to the body weight scales 2, and sets the value as the first reference value R1. In Embodiment 1, as an example, it is assumed that a weight of the litter 16 and the upper unit 17 is 3 kg. Note that, by the user, a first threshold M1. is set on the first reference value setting section 23, and a second threshold M2 and a third threshold M3 are set on the offset determining section 24.

The first threshold M1 is a threshold in accordance with which the first reference value setting section 23 determines whether or not, by the upper unit 17 being detached, the body weight scales 2 are brought into a state in which no load is applied to the body weight scales 2. The first threshold M1 can be the weight of the litter 16 and the upper unit 17. The second threshold M2 is a threshold in accordance with which the offset determining section 24 determines whether the measurement value W, shown by the body weight scales 2 while the upper unit 17 is detached and no load is accordingly applied to the body weight scales 2, is likely to be a value obtained by adding the offset to the second reference value R2 which is already set.

The third threshold M3 is a threshold in accordance with which the offset determining section 24 determines whether or not the amount of the offset falls within a given range, in a case where the offset determining section 24 determines, a plurality of times, that the measurement value W, shown by the body weight scales 2 while the upper unit 17 is detached and no load is accordingly applied to the body weight scales 2, is likely to be a value obtained by adding the offset to the second reference value R2.

As illustrated in FIG. 4, the measurement value W, shown by the body weight scales 2 while the upper unit 17 is detached and no load is accordingly applied to the body weight scales 2, is the initial measurement value Wo. In a case where the upper unit 17 on which the litter 16 is laid is disposed on the body weight scales 2, the measurement value W shown by the body weight scales 2 varies from the initial measurement value Wo to the steady-state value Wu. In a case where the pet steps onto the litter 16 laid on the upper unit 17, the measurement value W shown by the body weight scales 2 increases from the steady-state value Wu to a value We by the weight of the pet. In a case where the pet on the litter 16 moves away from the upper unit 17, the measurement value W shown by the body weight scales 2 returns from the value We to the steady-state value Wu. Note that the first reference value setting section 23 sets, as the first reference value R1, the steady-state value Wu which is the measurement value W that is uniform for the longest time period.

In a case where the upper unit 17 is detached from the body weight scales the measurement value W shown by the body weight scales 2 decreases to the initial measurement value Wo from the steady-state value Wu, that is, the first reference value R1. Since an amount of a decrease in the measurement value W to the initial measurement value Wo is greater than the first threshold M1, the first reference value setting section 23 estimates that the body weight scales 2 are in a state in which no load is applied to the body weight scales 2.

Next, since a difference between (i) the measurement value W which has been shown by the body weight scales 2 and in accordance with which it has been estimated that the body weight scales 2 are in a state in which no load is applied to the body weight scales 2 and the initial measurement value Wo, that is, the second reference value R2 is equal to or smaller than the second threshold M2, the offset determining section 24 estimates that the offset is not added to the measurement value W shown by the body weight scales 2. The offset determining section 24 then adds “1” to the number of counts C which are done by the counter 24a.

As illustrated in FIG. 5, in a case where a decrease in the measurement value W, shown by the body weight scales 2, from the steady-state value Wu (i.e., the first reference value R1) by the first threshold M1 or more is repeated a given number of times, that is, in a case where the number of counts C which are done by the counter 24a reaches a given number, for example, 10, the offset determining section 24 determines that the offset is not added to the measurement value W shown by the body weight scales 2. The offset determining section 24 then returns the number of counts C, which are done by the counter 24a, to 0 (zero).

Subsequently, in a case where (i) the amount of the decrease in the measurement value W shown by the body weight scales 2 becomes greater than the first threshold M1 and (ii) the difference between (a) the measurement value W shown at that time and (b) the second reference value R2 is equal to or smaller than the second threshold M2, the offset determining section 24 again estimates that the offset is not added to the measurement value W shown by the body weight scales 2. The offset determining section 24 again repeats this process a given number of times, for example, 10 times.

Note that, as indicated by an arrow A2 illustrated in FIG. 5, in a case where the amount of the decrease in the measurement value W, shown by the body weight scales 2, from the steady-state value Wu (i.e., first reference value R1) is smaller than the first threshold M1, for example, 1 (one) kg, the first reference value setting section 23 does not consider that the measurement value W shown at that time indicates a state in which no load is applied to the body weight scales 2. Therefore, the offset determining section 24 also does not consider the measurement value W shown at that time by the body weight scales 2, and does not change the number of counts which are done by the counter 24a.

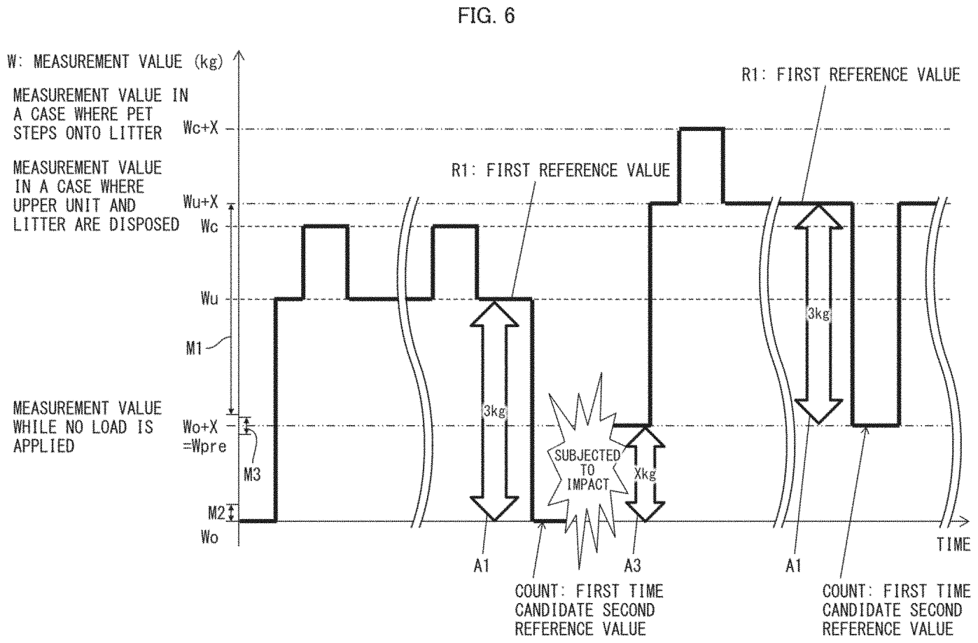

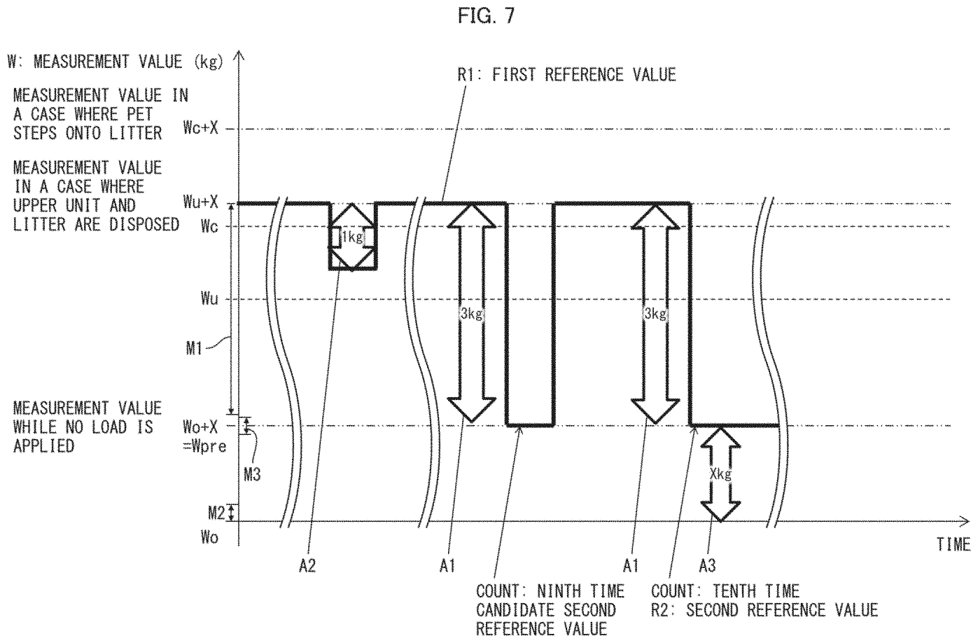

FIG. 6 is a view illustrating a state in which, in the pet toilet 1 in accordance with Embodiment 1, the determination of whether or not the offset is added is started on the basis of the variation with time in the measurement value shown by the body weight scales 2 while the offset is added. FIG. 7 is a view illustrating a state in which, in the pet toilet 1 in accordance with Embodiment 1, it is determined that the offset is added, on the basis of the variation with time in the measurement value shown by the body weight scales 2 while the offset is added.

As illustrated in FIG. 6, the measurement value W, shown by the body weight scales 2 while the upper unit 17 is detached and no load is accordingly applied to the body weight scales 2, is the initial measurement value Wo. Since the difference between (i) the measurement value W shown at that time and (ii) the second reference value R2 is equal to or smaller than the second threshold M2, the offset determining section 24 estimates that the offset is not added to the measurement value W shown by the body weight scales 2.

Here, it is assumed that (i) some impact occurs because, for example, the upper unit 17 is dropped before the upper unit 17 which has been detached is disposed on the body weight scales 2 and (ii) the offset (deviation) is accordingly added to the measurement value W shown by the body weight scales 2. It is assumed here that, as indicated by an arrow A3, the offset of +X kg is added to the measurement value W shown by the body weight scales 2. In this case, although no load is applied to the body weight scales 2, the body weight scales 2 output, as the measurement value W, not the initial measurement value Wo but an initial measurement value Wo+X which is a value after the offset is added.

However, in many cases, at a time when the offset is added to the measurement value shown by the body weight scales 2, the user does not recognize that the offset is added to the measurement value shown by the body weight scales 2. Therefore, the upper unit 17 on which the litter 16 is laid is disposed by the user, in a state in which the offset is added to the measurement value shown by the body weight scales 2. Accordingly, the measurement value W shown by the body weight scales 2 varies from the initial measurement value Wo+X to a steady-state value Wu+X. In a case where the pet steps onto the litter 16 laid on the upper unit 17, the measurement value W shown by the body weight scales 2 increases from the steady-state value Wu+X to a value Wc+X by the weight of the pet. In a case where the pet on the litter 16 moves away from the upper unit 17, the measurement value W shown by the body weight scales 2 returns from the value Wc+X to the steady-state value Wu+X.

After the offset is added to the measurement value shown by the body weight scales 2, the steady-state value Wu+X is a value which is uniform for the longest time period, in a state in which the pet toilet 1 is in normal use. Therefore, the first reference value setting section 23 newly sets the steady-state value Wu+X as the first reference value R1.

Next, in a case where the upper unit 17 is detached from the body weight scales 2, the measurement value W shown by the body weight scales 2 decreases to the initial measurement value Wo+X from the steady-state value Wu+X, that is, the first reference value R1 which is newly set. Since an amount of a decrease in the measurement value W to the initial measurement value Wo+X is greater than the first threshold M1 (see an arrow A1), the first reference value setting section 23 estimates that the body weight scales 2 are in a state in which no load is applied to the body weight scales 2.

Since a difference between (i) the initial measurement value Wo+X, which is the measurement value W shown by the body weight scales 2 and in accordance with which it has been estimated that the body weight scales 2 are in a state in which no load is applied to the body weight scales 2, and (ii) the second reference value R2 (i.e., the initial measurement value Wo) is greater than the second threshold M2, the offset determining section 24 determines that the offset is likely to be added to the measurement value W shown by the body weight scales 2. The offset determining section 24 then stores the initial measurement value Wo+X, which is the measurement value W shown at that time, in the storage section 27 as a candidate second reference value Wpre, and adds 1 (one) to the number of counts C which are done by the counter 24a.

Thereafter, as illustrated in FIG. 7, each time the measurement value W shown by the body weight scales 2 decreases by the first threshold M1 or more from the steady-state value Wu+X (i.e., the first reference value R1), the offset determining section 24 (i) determines that the difference between (a) the initial measurement value Wo+X, which is the measurement value W shown at that time, and (b) the second reference value R2 (i.e., the initial measurement value Wo) is greater than the second threshold M2, (ii) stores the candidate second reference value Wpre in the storage section 27, and then (iii) adds 1 (one) to the number of counts C which are done by the counter 24a.

Note that, in a case where the offset determining section 24 sets the candidate second reference value Wpre, the offset determining section 24 compares the candidate second reference value Wpre which has been newly set and the candidate second reference value Wpre which has been previously stored in the storage section 27, before the offset determining section 24 stores, in the storage section 27, the candidate second reference value Wpre which has been newly set. In a case where the candidate second reference value Wpre which has been newly set differs, by the third threshold M3 or less, from the candidate second reference value Wpre which has been previously stored in the storage section 27, the offset determining section 24 stores, in the storage section 27, the candidate second reference value Wpre which has been newly set. The offset determining section 24 thus determines that a new offset has not been added to the measurement value, shown by the body weight scales 2, since the candidate second reference value Wpre was previously stored in the storage section 27, and continues counting with use of the counter 24a. In a case where the candidate second reference value Wpre which has been newly set differs, by more than the third threshold M3, from the candidate second reference value Wpre which has been previously stored in the storage section 27, the offset determining section 24 stores, in the storage section 27, the candidate second reference value Wpre which has been newly set, and returns the number of counts C, which are done by the counter 24a, to 0 (zero). The offset determining section 24 thus determines that a new offset has been added to the measurement value, shown by the body weight scales 2, since the candidate second reference value Wpre was previously stored in the storage section 27, and starts counting again from 1 (one) with use of the counter 24a.

In a case where the number of counts C, which are done by the counter 24a, reaches the given number, for example, 10, the offset determining section 24 determines that the offset is added to the measurement value W shown by the body weight scales 2. It is possible to, in the control device 20, thus detect addition of the offset to the measurement value W shown by the body weight scales 2. After the offset determining section 24 determines that the offset is added to the measurement value W shown by the body weight scales 2, the notification processing section 25 can cause, as necessary, the user to be notified of information indicative of a fact that the offset is added to the second reference value R2. This allows the user to recognize that the measurement value W, shown by the body weight scales 2 while no load is actually applied to the body weight scales 2, is not 0 (zero) kg (=Wo) but a value to which the offset (Wo+X) is added. Therefore, it is possible for the user to adjust, by him-/herself, the measurement value W shown by the body weight scales 2 or alternatively take necessary action, for example, ask a manufacturer to repair the body weight scales 2.

Even in a case where (i) the offset determining section 24 determines that the offset is added to the measurement value W shown by the body weight scales 2 and (ii) the notification processing section 25 does not cause the user to be notified of the information, the control device 20 is capable of causing a function, which is realized with use of an absolute value of the measurement value W shown by the body weight scales 2, to be correctly carried out even in a state in which the offset is added to the measurement value W shown by the body weight scales 2. Note that examples of the function which is realized by the control device 20 with use of the absolute value of the measurement value W shown by the body weight scales 2 include a function of causing the pet toilet 1 to operate in an electric power saving mode while the upper unit 17 is not disposed.

Note that the notification processing section 25 can cause the user to be notified of the information, each time the offset determining section 24 determines that the offset is added to the measurement value W shown by the body weight scales 2. Alternatively, the notification processing section 25 can cause the user to be notified of a fact that a repair is needed, after the offset determining section 24 determines that the offset of a certain value or more is added to the measurement value W shown by the body weight scales 2.

As has been described, the offset determining section 24 determines that the offset is added to the measurement value W shown by the body weight scales 2, after the offset determining section 24 stores the candidate second reference value Wpre the given number of times (for example, 10 times This makes it possible to enhance accuracy with which it is determined that the measurement value W, shown by the body weight scales 2 while no load is actually applied to the body weight scales 2, is deviated.

Note that the offset determining section 24 can be arranged so as to determine that the offset is added to the measurement value W shown by the body weight scales 2, not after the offset determining section 24 stores the candidate second reference value Wpre in the storage section 27 the given number of times, but immediately after the offset determining section 24 stores the candidate second reference value Wpre in the storage section 27 only once. This allows the offset determining section 24 to recognize that the offset is added to the measurement value W shown by the body weight scales 2, immediately after the offset is added to the measurement value W shown by the body weight scales 2. Therefore, it is possible to cause the user to more immediately recognize that the offset is added to the measurement value W shown by the body weight scales 2 (Wo+X).

### Flow of Process Carried Out by Control Device 20

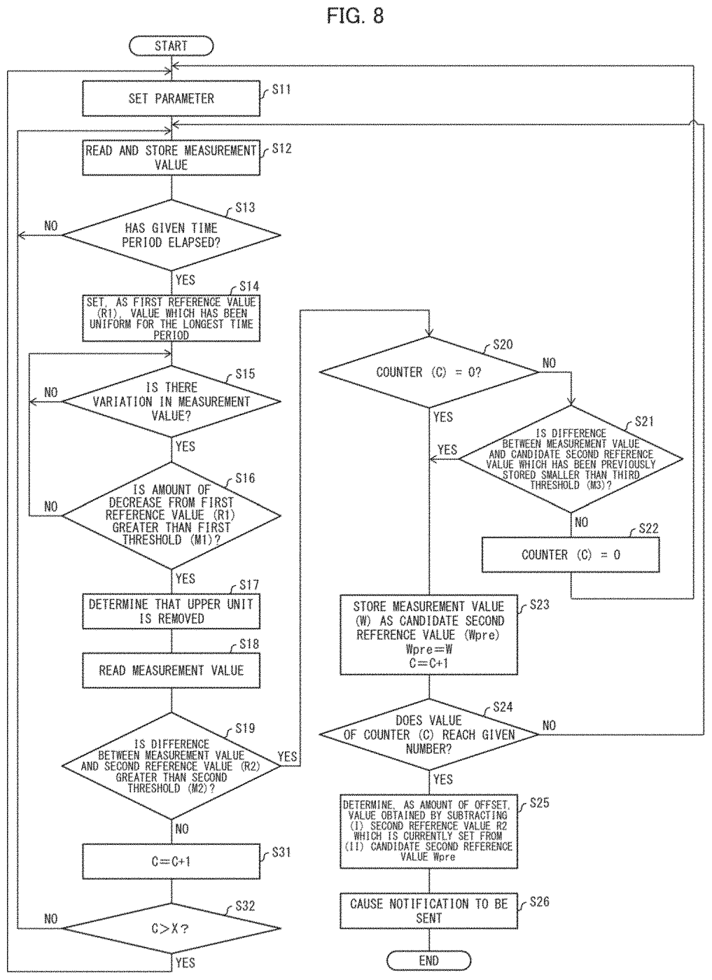

FIG. 8 is a flowchart illustrating a flow of a process carried out by the control device 20 of the pet toilet 1 in accordance with Embodiment 1. First, the user sets and registers various parameters in the control section 21 (steps S11). The offset determining section 24 resets the number of counts C, which are done by the counter 24a, so that the number of counts C becomes 0 (zero). Next, the measurement value obtaining section 22 obtains, over time, the information indicative of the measurement value shown by the body weight scales 2, from the body weight scales 2, and stores the measurement value thus obtained in the storage section 27 and also in the server 5 via the communication section 40 (step S12).

The first reference value setting section 23 then determines whether or not the given time period (for example, 24 hours) has elapsed since the measurement value obtaining section 22 started obtaining the information indicative of the measurement value from the body weight scales 2 (step S13). In a case where, in the step S13, the first reference value setting section 23 determines that the given time period has not elapsed yet (NO in the step S13), the process returns to the step S12. In a case where, in the step S13, the first reference value setting section 23 determines that the given time period has elapsed (YES in the step S13), the first reference value setting section 23 refers to the storage section 27, and sets, as the first reference value R1, the measurement value which has been shown by the body weight scales 2 and which has been uniform for the longest time period within the given time period (step S14). That is, the first reference value setting section 23 determines that the measurement value which has been shown by the body weight scales 2 and which has been uniform for the longest time period within the given time period indicates a state in which the steady-state load is applied to the body weight scales 2 and thereby the pet toilet 1 is caused to stand by.

Next, the offset determining section 24 monitors the measurement value shown by the body weight scales 2 and sequentially stored in the storage section 27, and determines whether or not there is any variation in the measurement value (step S15). In a case where, in the step S15, the offset determining section 24 determines that there is a variation in the measurement value (YES in the step S15), the offset determining section 24 determines whether or not (i) the variation in the measurement value indicates a decrease from the first reference value R1 set by the first reference value setting section 23 and (ii) an amount of the decrease is greater than the first threshold M1 set in advance (step S16).

In a case where, in the step S16, the offset determining section 24 determines that the variation in the measurement value shown by the body weight scales 2 does not indicate a decrease from the first reference value R1 or that the variation in the measurement value shown by the body weight scales 2 indicates a decrease from the first reference value R1 but an amount of the decrease is equal to or smaller than the first threshold M1 (NO in the step S16), the process returns to the step S15. In a case where, in the step S16, the offset determining section 24 determines that the variation in the measurement value W shown by the body weight scales 2 indicates a decrease from the first reference value R1 and an amount of the decrease is greater than the first threshold M1 set in advance (YES in the step S16), the offset determining section 24 determines that the upper unit 17 is detached (step S17). That is, the offset determining section 24 determines that the body weight scales 2 are in a state in which no load is applied to the body weight scales 2.

Next, the offset determining section 24 reads the measurement value W which has been shown by the body weight scales 2 and in accordance with which it has been determined that the upper unit 17 is detached (step S18). The offset determining section 24 then determines whether or not a difference between the measurement value W thus read and the second reference value R2 is greater than the second threshold M2 set in advance (step S19).

In a case where, in the step S19, the offset determining section 24 determines that the difference between such a read measurement value W and the second reference value R2 is not greater than the second threshold M2 set in advance (NO in the step S19), the offset determining section 24 adds 1 (one) to the number of counts, which are done by the counter 24a, so that C=C+1 (step S31). That is, the counter 24a increases the number of counts by 1 (one)

Next, the offset determining section 24 determines whether or not the number of counts C, which are done by the counter 24a, reaches the given number (step S32). In a case where, in the step S32, the offset determining section 24 determines that the number of counts C, which are done by the counter 24a, does not reach the given number (NO in the step 32), the process carried out by the control section 21 returns to the step S12. The offset determining section 24 then estimates that the measurement value W shown while no load is applied to the body weight scales 2 is not a value obtained by adding the offset to the second reference value R2 which is currently set. In a case where, in the step S32, the offset determining section 24 determines that the number of counts C, which are done by the counter 24a, reaches the given number (YES in the step 32), the process carried out by the control section 21 returns to the step S11. As a result, the number of counts C, which are done by the counter 24a, is reset. Further, the offset determining section 24 determines that the measurement value W shown while no load is applied to the body weight scales 2 is not a value obtained by adding the offset to the second reference value R2 which is currently set.

In a case where, in the step S19, the offset determining section 24 determines that the difference between the read measurement value W and the second reference value R2 is greater than the second threshold M2 set in advance (YES in the step S19), the offset determining section 24 next determines whether or not the number of counts C, which are done by the counter 24a, is 0 (zero) (step S20).

In a case where, in the step S20, the offset determining section 24 determines that the number of counts C. which are done by the counter 24a, is 0 (zero) (YES in the step S20), the offset determining section 24 stores, in the storage section 27, the read measurement value W as the candidate second reference value Wpre. Furthermore, the offset determining section 24 adds 1 (one) to the number of counts, which are done by the counter 24a, so that C=C+1 (step S23). That is, the counter 24a increases the number of counts by 1 (one).

Next, the offset determining section 24 determines whether or not the number of counts C, which are done by the counter 24a, reaches the given number (step S24). In a case where, in the step S24, the offset determining section 24 determines that the number of counts C, which are done by the counter 24a, does not reach the given number (NO in the step S24), the process carried out by the control section 21 returns to the step S12. In a case where, in the step S24, the offset determining section 24 determines that the number of counts C, which are done by the counter 24a, reaches the given number (YES in the step S24), the offset determining section 24 next determines, as an amount of the offset, a value obtained by subtracting (i) the second reference value R2 which is currently set from the candidate second reference value Wpre which has been used in last determination (step S25). Thereafter, the notification processing section 25 carries out a given process so as to cause a notification to be sent (Step S26).

In a case where, in the step S20, the offset determining section 24 determines that a value of the counter 24a is not 0 (zero) (NO in the step S20), the offset determining section 24 determines whether or not a difference between the read measurement value W and the candidate second reference value Wpre which has been previously stored is smaller than the third threshold M3 set in advance (step S21). The offset determining section 24 thus determines whether or not the read measurement value W is similar to the measurement value W which has been shown while no load is applied to the body weight scales 2 and which has been previously stored as the candidate second reference value Wpre.

In a case where, in the step S21, the offset determining section 24 determines that the difference between the read. measurement value W and the candidate second reference value Wpre which has been previously stored is not smaller than the third threshold M3 set in advance (NO in the step S21), the offset determining section 24 returns the number of counts C to 0 (zero) by causing the value of the counter 24a to be 0 (zero) (step S22). Then, the process carried out by the control section 21 returns to the step S11.

As has been described, in a case where, in the step S16, the first reference value setting section 23 determines that the measurement value W, which has been shown by the body weight scales 2 and which has been obtained by the measurement value obtaining section 22, has decreased from the first reference value R1 by more than the first threshold M1 (YES in the step S16), the first reference value setting section 23 estimates that the steady-state load which has been applied to the body weight scales 2 is removed (step S17), that is, no load is applied to the body weight scales 2. Then, in the step S19, the offset determining section 24 compares (i) the measurement value W which has decreased from the first reference value R1 by more than the first threshold M1 and (ii) the second reference value R2, and determines whether or not the difference between the measurement value W and the second reference value R2 is greater than the second threshold M2. Then, in a case where the offset determining section 24 determines that the difference between the measurement value W and the second reference value R2 is greater than the second threshold M2 (YES in the step S19), the offset determining section 24 stores, in the storage section 27, the measurement value W as the candidate second reference value Wpre in the step S23. The offset determining section 24 thus determines that the measurement value W in accordance with which it has been estimated that no load is applied to the body weight scales 2 is likely to be significantly deviated from the second reference value R2 which is currently set. This makes it possible to cause the user to recognize that the offset is likely to be added to the measurement value W, by, for example, causing the notification to be sent to the user.

Further, in the step S21, the offset determining section 24 determines whether or not the difference between (i) the candidate second reference value Wpre which has been newly stored in the storage section 27 and (ii) the candidate second reference value Wpre which has been previously stored in the storage section 27 is smaller than the third threshold M3. With this determination, in a case where the candidate second reference value which has been newly stored significantly differs from the candidate second reference value which has been previously stored, it is possible to recognize that the measurement value W, shown by the body weight scales 2 while no load is actually applied to the body weight scales 2, is likely to be further deviated from the candidate second reference value Wpre which has been previously set.

This makes it possible to enhance accuracy with which it is determined whether or not the second reference value R2 which is currently set is deviated from the measurement value W shown by the body weight scales 2 while no load is actually applied to the body weight scales 2.

Note that an amount of the litter 16 laid on the excretion stage 12 slightly varies each time the upper unit 17 is detached and then disposed on the body weight scales 2. Therefore, the first reference value setting section 23 can be arranged so as to (i) at intervals of the given time period, extract, from the measurement value W sequentially stored in the storage section 27, the measurement value W which is uniform for the longest time period and (ii) correct the first reference value R1 on the basis of the measurement value W thus extracted. That is, the first reference value setting section 23 can be arranged so as to (i) calculate a statistical value, such as an average or a median, from the steady-state value Wu (or Wu+X) before the upper unit 17 is detached and the steady-state value Wu (or Wu+X) after the upper unit 17 is detached arid (ii) correct the first reference value R1 on the basis of the statistical value. This makes it possible to enhance accuracy of the first reference value R1. In other words, it is possible to enhance accuracy with which the first reference value setting section 23 determines whether or not the upper unit 17 is detached.

### Embodiment 2

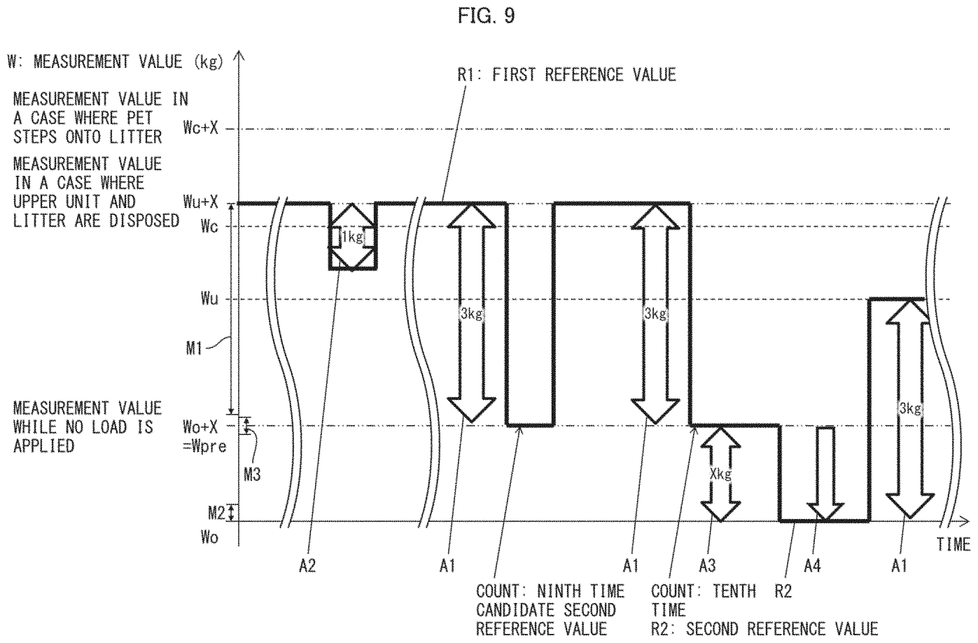

The following description will discuss Embodiment 2 of the present invention. Note that, for convenience, an identical reference numeral will be given to a member having a function identical to that of a member described in Embodiment 1, and description of the member will be omitted. FIG. 9 is a view illustrating a state in which, in a pet toilet 1 in accordance with Embodiment 2, (i) it is determined that an offset is added, on the basis of a variation with time in a measurement value shown by body weight scales 2 while the offset is added and (ii) the offset is corrected. A configuration of the pet toilet 1 in accordance with Embodiment 2 is similar to that illustrated in FIGS. 1 through 3.

As illustrated in FIG. 9, according to Embodiment 2, in a case where the number of times an offset determining section 24 determines that a difference between a candidate second reference value Wpre and (ii) the candidate second reference value Wpre which has been previously stored is smaller than a third threshold reaches a given number, for example, 10 (YES in the step S24 illustrated in FIG. 8), the offset determining section 24 determines, as an amount of the offset (offset amount) X, a value obtained by subtracting (a) a second reference value R2 (=Wo) which is currently set from (b) the candidate second reference value Wpre which has been used in last determination (the step S25 illustrated in FIG. 8), and thus calculates the offset amount X (an arrow A3 illustrated in FIG. 9). The offset determining section 24 then corrects, to the second reference value R2 (=Wo), the candidate second reference value Wpre which has been used in the last determination, with use of the offset amount X thus calculated (an arrow A4 illustrated in FIG. 9. A measurement value W shown by the body weight scales 2 is corrected with use of such an offset value X.

This makes it possible to accurately keep, at 0 (zero), the measurement value W shown by the body weight scales 2 while no load is actually applied to the body weight scales 2. Since it is possible to eliminate the offset added to the measurement value shown by the body weight scales 2 without a user's operation, it is highly convenient. Furthermore, a notification processing section 25 can be arranged so as to cause a user to be notified of a fact that the offset determining section 24 has corrected the measurement value W shown by the body weight scales 2.

Alternatively, the offset determining section 24 can be arranged as follows, That is, in a case where the number of tunes the offset determining section 24 determines that the difference between (i) the candidate second reference value Wpre and (ii) the candidate second reference value Wpre which has been. previously stored is smaller than the third threshold reaches the given number, for example, 10 (YES in the step S24 illustrated, in FIG. 8), the offset determining section 24 goes back in time by the number of tunes, and corrects, with use of the offset amount X, the measurement value W which has been shown by the body weight scales 2 and has been stored in a storage section 27 and which corresponds to each of those candidate second reference values Wpre. For example, the offset determining section 24 corrects, with use of the offset amount X, the measurement value W ranging from (i) one that corresponds to the candidate second reference value Wpre which has been stored in the storage section 27 in a case where the number of counts C, which are done by a counter 24a, is 0 (zero) to (ii) one that corresponds to the candidate second reference value Wpre which has been stored in the storage section 27 last time. This makes it possible to correct, to a more accurate measurement value W, the measurement value W which has been already stored in the storage section 27 and to which the offset is added (that is, C+X),

### Embodiment 3

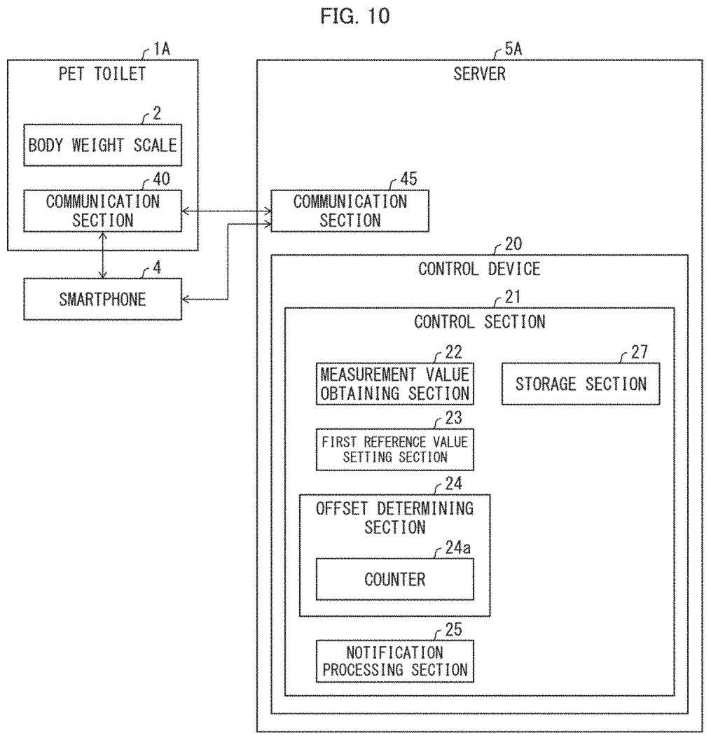

The following description will discuss Embodiment 3 of the present invention. Note that, for convenience, an identical reference numeral will be given to a member having a function identical to that of a member described in Embodiment 1 or 2, and description of the member will be omitted. FIG. 10 is a block diagram illustrating a configuration of a pet toilet 1A, a smartphone 4, and a server 5A in accordance with Embodiment 3. The pet toilet 1A is configured not to include the control device 20 included in the pet toilet 1. The server 5A includes a control device 20 and a communication section 45, in addition to the configuration of the server 5. In this manner, the control device 20 can be provided, not to the pet toilet 1A, but to the server 5A. The communication section 45 conducts communication with a communication section 40 of the pet toilet 1A or the smartphone 4 via a telecommunication line such as the Internet. A measurement value obtaining section 22 obtains, via the communication section 40 and the communication section 45, information indicative of measurement value W shown by body weight scales 2 which are included in the pet toilet 1A.

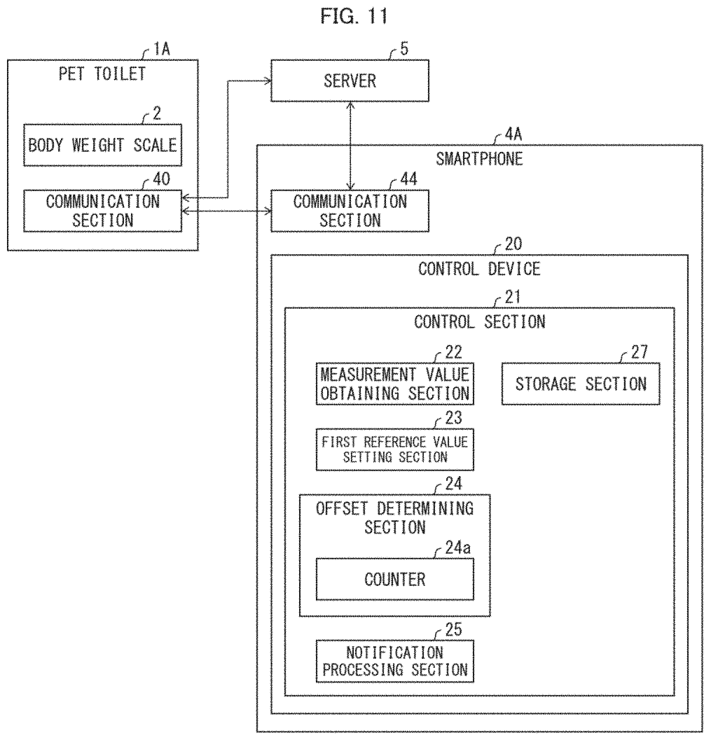

FIG. 11 is a block diagram illustrating a configuration of a pet toilet 1A, a smartphone 4A, and a server 5 in accordance with another aspect of Embodiment 3. The smartphone 4A includes a control device 20 and a communication section 44, in addition to the configuration of the smartphone 4. In this manner, the control device 20 can be provided, not to the pet toilet 1A nor to the server 5, but to the smartphone 4A. The communication section 44 conducts communication with the server 5 via a telecommunication line such as the Internet. The communication section 44 can conduct communication with a communication section 40 of the pet toilet 1A via a telecommunication line such as the Internet or can alternatively conduct near field communication with the communication section 40. A measurement value obtaining section 22 obtains, via the communication section 40 and the communication section 44, information indicative of a measurement value W shown by body weight scales 2 which are included in the pet toilet 1A.

### Software Implementation Example

A control block (particularly, the measurement value obtaining section 22, the first reference value setting section 23, the offset determining section 24, and the notification processing section 25) of the control device 20 can be realized by a logic circuit (hardware) provided on, for example, an integrated circuit (IC chip) or can be alternatively realized by software.

In the latter case, the control device 20 includes a computer which executes instructions of a program that is software realizing the foregoing functions. The computer includes, for example, at least one processor (control device) and at least one computer-readable storage medium which stores therein the program. By, in the computer, the processor reading the program from the storage medium and executing the program, the object of an aspect of the present invention is attained. Examples of the processor include central processing units (CPUs). Examples of the storage medium include “non-transitory tangible mediums” such as a tape, a disk, a card, a semiconductor memory, and a programmable logic circuit, as well as a read only memory (ROM). The computer can further include a random access memory (RAM) or the like in which the program is loaded. The program can be supplied to or made available to the computer via any transmission medium (such as a communication network or a broadcast wave) which allows the program to be transmitted. Note that an aspect of the present invention can also be achieved in the form of a computer data signal in which the program is embodied via electronic transmission and which is embedded in a carrier wave.

Note that the present invention is not limited to the embodiments, but can be altered by a skilled person in the art within the scope of the claims. The present invention also encompasses, in its technical scope, any embodiment derived by combining technical means disclosed in differing embodiments. Further, it is possible to form a new technical feature by combining the technical means disclosed in the respective embodiments.

### REFERENCE SIGNS LIST

1, 1A Pet toilet (animal toilet)
2 Body weight scale (weight scale)
3 Excreta weight scale
4, 4A Smartphone (information processing terminal)
5, 5 A Server (information processing device)
11 Main container
12 Excretion stage
12a Mesh part
13 Excreta tray
14 Absorbing sheet
15 Supporting plate
17 Upper unit
20 Control device
21 Control section
22 Measurement value obtaining section
23 First reference value setting section
24 Offset determining section
24a Counter
25 Notification processing section
27 Storage section
40, 44, 45 Communication section
M1 First threshold
M2 Second threshold
M3 Third threshold
R1 First reference value
R2 Second reference value
Wo Initial measurement value
Wpre Candidate second reference value
Wu Steady-state value

1. A control device which controls an animal toilet, the control device comprising:
a measurement value obtaining section which obtains, over time, information indicative of a measurement value shown by a weight scale that is included in the animal toilet and that measures a body weight of an animal;
a first reference value setting section which sets, as a first reference value, the measurement value shown by the weight scale while a steady-state load is applied to the weight scale; and
an offset determining section which sets, as a second reference value, the measurement value shown by the weight scale and regarded as a measurement value shown while no load is applied to the weight scale,
in a case where the measurement value, which has been shown by the weight scale and which has been obtained by the measurement value obtaining section, has decreased from the first reference value by more than a first threshold, the offset determining section determining whether or not a difference between the measurement value and the second reference value is greater than a second threshold,
in a case where the offset determining section determines that the difference between the measurement value and the second reference value is greater than the second threshold, the offset determining section storing the measurement value as a candidate second reference value.

2. The control device as set forth in claim 1, wherein the offset determining section determines whether or not a difference between (i) the candidate second reference value which has been stored and (ii) the candidate second reference value which has been previously stored is smaller than a third threshold.

3. The control device as set forth in claim 2, further comprising a notification processing section which causes a user to be notified of information indicative of a fact that an offset is added to the second reference value, in a case where the number of times the offset determining section determines that the difference between (i) the candidate second reference value which has been stored and (ii) the candidate second reference value which has been previously stored is smaller than the third threshold reaches a given number.

4. The control device as set forth in claim 2, wherein in a case where the number of times the offset determining section determines that the difference between (i) the candidate second reference value which has been stored and (ii) the candidate second reference value which has been previously stored is smaller than the third threshold reaches a given number, the offset determining section calculates, as an amount of an offset, a difference between (a) the second reference value and (b) the candidate second reference value which has been used in last determination, and corrects, with use of the amount of the offset, the measurement value shown by the weight scale.

5. The control device as set forth in claim 3, wherein the given number is two or more.

6. The control device as set forth in claim 4, further comprising
a storage section in which the measurement value, which has been shown by the weight scale and which has been obtained by the measurement value obtaining section, is stored on a time-series basis,
in a case where the offset determining section determines, a plurality of times, that the difference between (i) the candidate second reference value which has been stored and (ii) the candidate second reference value which has been previously stored is smaller than the third threshold, the offset determining section going back in time by the plurality of times, and correcting, with use of the amount of the offset, the measurement value which has been shown by the weight scale and has been stored in the storage section and which corresponds to each of (i) the candidate second reference value which has been stored and (ii) the candidate second reference value which has been previously stored.

7. The control device as set forth in claim 1, further comprising
a storage section in which the measurement value, which has been shown by the weight scale and which has been obtained by the measurement value obtaining section, is stored on a time-series basis,
the first reference value setting section setting, as the first reference value, the measurement value which is uniform for the longest time period within a given time period.

8. The control device as set forth in claim 7, wherein the first reference value setting section extracts, at intervals of the given time period, the measurement value which is uniform for the longest time period, and corrects the first reference value on the basis of the measurement value extracted.

9. The control device as set forth in claim 1, wherein the steady-state load applied to the weight scale includes a weight of a main container onto which the animal steps and a weight of litter which is laid on a bottom of the main container.

10. An animal toilet comprising:
a control device recited in claim 1; and
a weight scale.

11. An information processing device comprising
a control device recited in claim 1,
the measurement value obtaining section obtaining information indicative of a measurement value shown by a weight scale which is included in an animal toilet.

12. An information processing terminal comprising
a control device recited in claim 1,
the measurement value obtaining section obtaining information indicative of a measurement value shown by a weight scale which is included in an animal toilet.

13. A control method carried out by a control device which controls a measurement value shown by a weight scale that measures a body weight of an animal, the control method comprising:
a measurement value obtaining step of obtaining, over time, information indicative of a measurement value shown by the weight scale;
a first reference value setting step of setting, as a first reference value, the measurement value shown by the weight scale while a steady-state load is applied to the weight scale; and
a second reference value setting step of setting, as a second reference value, the measurement value shown by the weight scale and regarded as a measurement value shown while no load is applied to the weight scale,
in the second reference value setting step,
in a case where the measurement value, which has been shown by the weight scale and which has been obtained in the measurement value obtaining step, has decreased from the first reference value by more than a first threshold, it being determined whether or not a difference between the measurement value and the second reference value is greater than a second threshold,
in a case where it is determined that the difference between the measurement value and the second reference value is greater than the second threshold, the measurement value being set as a candidate second reference value.
